(19) United States
(12) Patent Application Publication
(10) Pub. No.: US 2009/0227484 A1
(43) Pub. Date: Sep. 10, 2009

(54) DETERGENT BODY

(75) Inventors: Judith Preuschen, Ludwigshafen (DE); Ralf Wiedemann, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (DE)

(21) Appl. No.: 11/909,692

(22) PCT Filed: Apr. 5, 2006
(86) PCT No.: PCT/GB06/01252

§ 371 Date: Nov. 13, 2007

(30) Foreign Application Priority Data
Apr. 7, 2005 (GB) 0507069.3

(51) Int. Cl. C11D 17/00; B29C 45/77

(52) U.S. Cl. 510/224; 510/441; 264/328.17

(57) ABSTRACT

The invention provides multi-phase detergent body comprises in one phase a dispersible/soluble detergent formulation and in a second phase a non-water soluble/dispersible body which, at least partially, encloses the detergent formulation. The body is prepared in an injection moulding process. Also provided is an injection moulding process for the preparation of a multi-phase detergent body.

The present invention relates to a detergent body. The body is prepared by injection moulding.

In applications involving washing agents, detergents and other detergent formulation components, tablets have established a place for themselves on the market in recent years as a format that provides easy metering and is simple to use.

Tablets typically comprise a mixture of components that are solid at room temperature and components that are liquid at room temperature. Commonly the solid components are present in granular form for ease of processing and speed of dissolution/dispersion.

The tablets are normally prepared by admixture of the tablet components followed by compaction to a shaped body. These compressed tablets suffer from several disadvantages.

Firstly, even though the compaction pressure used is high the tablets are still friable. This leads to dust formation and, in some cases, tablet breakage. This problem has not been successfully addressed by the incorporation of binders within the tablet.

Additionally, as the tablet components are usually highly hygroscopic, on exposure to atmospheric air, the tablet absorbs moisture. With moisture absorption the tablet deforms and eventually looses its structural integrity.

To counter this effect a water resistant container/wrapper is required to ensure tablet stability, requiring an additional step in the manufacturing process.

These and other disadvantages are also relevant for multi-phase tablets, tablets which contain one or more component formulations commonly present in a layered arrangement/body with insert formation.

Multi-phase tablets also suffer from complex manufacturing techniques: either a complex multi-stage manufacturing process involving a number of layers being compressed together (after possible separate pre-formation) and/or the insertion of an insert into cavity of a pre-formed body is required.

For the layered structures a compromise has to be reached between a sufficiently high compression pressure so that the layers are adequately bonded together and a sufficiently low compression pressure so that tablet in-wash dissolution/dispersion time is not unduly prolonged. This compromise often has unsatisfactory results leading to tablets having poor stability with detrimental effects such as layer separation.

For the tablets having an insert, there is the issue of insert addition which requires a highly precise manufacturing process and the problem of insert separation caused by poor adhesion to the tablet body.

Detergent tablets may also be prepared using extrusion techniques. In this method the tablet components are inserted into an intrusion device and extruded.

Tablets produced in this way also suffer from several disadvantages.

Most of the disadvantages arise as a result of the fundamentals of the extrusion process: the extrudate is typically tubular, which is then divided into tablet portions, usually in a cutting technique. It has been found to be very difficult to cut the extrudate into individual tablets without causing deformation to the tablet. Thus the tablets produced are not rectilinear but instead are distorted, especially around the cut edges.

Additionally due to the manner in which the extrudate is produced there is virtually no flexibility in the shape of the final tablet (with the exception of the shape of the extrusion die): the extruded tablets must be based on a kind of tubular form. This problem is particularly exacerbated for multi-phase tablets.

Also for multi-phase tablets there is a further disadvantage in that little or no flexibility is allowed in the relative proportions in the phases. This problem is described more clearly in Patent Application WO-A-01/02532. Herein a multi-phased tablet (in this case two phases) is described, in which of the two phases the minor phase has to have a thickness of at least 5 mm for the integrity of the tablet to be preserved.

It is an object of the present invention to mitigate/overcome the problems outlined above.

Thus according to a first aspect the present invention provides a multi-phase detergent body, the multi-phase detergent body comprising in one phase a dispersible/soluble detergent formulation and in a second phase a non-water soluble/dispersible body which, at least partially, encloses the dispersible/soluble detergent formulation, the body being prepared in an injection moulding process.

According to a second aspect the present invention provides an injection moulding process for the preparation of a multi-phase detergent body, the multi-phase detergent body comprising in one phase a dispersible/soluble detergent formulation and in a second phase a non-water soluble/dispersible body which, at least partially, encloses the dispersible/soluble detergent formulation.

According to the third aspect of the invention there is provided a multi-phase body, the multi-phase body comprising in one phase a first formulation and in a second phase a body which, at least partially, encloses the detergent formulation, the body being prepared in an injection moulding process.

Most preferably the first formulation according to the third aspect comprises a dispersible detergent formulation. Alternatively the first formulation may be a wax formulation, such as a candle.

According to the third aspect of the invention the second phase which at least partially encloses the first formulation, may be either water soluble/dispersible or non-water soluble/dispersible as desired.

For the avoidance of doubt, the multi-purpose detergent body according to the first aspect of the invention comprises a water dispersible/soluble detergent formulation in contrast to the second phase which is non-water soluble/dispersible. Furthermore the first formulation according to the third aspect also comprises a water dispersible detergent formulation in contrast to the possibility of it being a wax formulation. Unless otherwise stated or the context so requires, all percentages herein are percentages by weight.

We have surprisingly found that multi-phase detergent bodies can be processed in an injection moulding process into a detergent body.

Furthermore, the bodies have been found to have excellent physical properties including very smooth/glossy external surfaces and extremely low friability. Indeed friability has been found to be especially low at the apexes of the detergent body. Thus the problems exhibited by prior art tablet compositions of dust formation/high friability have been addressed.

Water-soluble packages (which may contain two compartments) comprising a detergent composition and which may be produced by thermoforming or injection moulding are described in GB 2 401 371 and WO 2004/081163.

Injection moulded receptacles for washing compositions are known from GB-A-2,361,010 and rigid water-soluble containers made of injection moulded poly(vinyl alcohol) and/or a cellulose ether encasing a fabric care, surface care or dishwashing composition are known from US 2003/0108705.

Detergent bars comprising a first and second distinct zone produced by an injection step are disclosed in US 2001/0039254.

Generally the detergent formulation comprises a binder.

The binder is preferably present at 5-50 wt %, more preferably 5-40 wt % and most preferably 10-30 wt % (e.g. such as between 10-20 wt %) of the formulation of the detergent formulation.

The binder is most preferably a thermo-plastic material.

Preferably the binder comprises a material which is solid at 30° C., most preferably at 35° C. Such material has been found to display excellent properties in body formation and body stability. More specifically the binder has been found to have the ability to aid the passage of the detergent body formulation into the injection moulding body and also to hold the body together after moulding.

Furthermore, the binder has been found to coat any solid component of the detergent formulation. This is advantageous as with the preferred binders, the previously observed problem of hygroscopicity of the solid components has been reduced. Also as the solid components are coated by the binder the problem of detrimental interaction of mutually incompatible solids (such as enzymes and bleaches) has been vastly reduced.

Preferred examples of binders include poly-ethylene-glycol (PEG) substituted and non-substituted synthetic and natural waxes (in both cases water soluble and non-water soluble, sugars and derivatives thereof, gelatine (combined with a sugar and/or a solvent (such as a liquid polyol, e.g. glycerine), non-ionic surfactants such as alkoxylated fatty acids/alcohols; water soluble or water dispersible oligomers and polymers (both substituted and non-substituted) such as poly-vinyl-alcohol (PVA), poly-vinyl-pyrrolidone (PVP), cellulose, polycarboxylic acids and co-polymers/derivatives thereof.

Most preferably the binder is PEG. Preferred examples of PEG have a molecular mass of 1500, 6000, 8000, 20000, 35000 or 8 million.

The detergent formulation preferably comprises a builder material. Preferred builder materials are of the oligocarboxylate or polycarboxylate type, such as compounds selected from the group consisting of citric acid (and salts, e.g. alkali metal salts thereof), methylglycinediacetic acid (and salts, e.g. alkali metal salts thereof), sodium polyacrylate (and its co-polymers), sodium gluconate and mixtures thereof. Most preferably the builder is an alkali metal (e.g. sodium/potassium) citrate salt.

Optionally the builder material at least partially comprises a phosphorous based builder, such as a tripolyphosphate, e.g. sodium and/or potassium tripolyphosphate.

The detergent formulation may comprise other conventional solid detergent components such as enzymes (e.g. proteases amylases or lipases), especially when in crystal-line/particulate format, bleaches (such as percarbonate or perborate compounds, chlorine bleach compounds and peracid compounds), bleach activators (such as TAED or metal catalysts) and alkalis (such as hydroxides/carbonates).

Generally the detergent formulation comprises a lubricant. Such a material has been found to display excellent properties in body formation. Namely the lubricant has the ability to facilitate the transport of the detergent formulation into/within the injection moulding mould.

This has a positive effect on the energy required for the required detergent body processes. Also it has an effect on reducing the wear of the injection mould equipment.

The lubricant is preferably present at 0.1 wt % to 10 wt %, preferably from 0.2 wt % to 5 wt %. It has been found that at such a small percentage the effect of the lubricant on the final shape of the detergent body is minimised.

Preferred examples of lubricants include; fatty acids and derivatives thereof, such as alkali metal and ammonium salts of fatty acid carboxylates (e.g. ammonium stearate, sodium oleate, potassium laureate), also PEG/glycerol functionalised with fatty acid carboxylates (e.g. PEG mono-oleate, PEG ricinoleate, glycerol mono-ricinoleate); sucrose glycerides; oils (olive oil, silicon oil, paraffin oil); and low melting point non-ionic surfactants.

The detergent formulation may have a soluble coating on a part not covered by the non-water soluble/dispersible body. Where present the coating may be employed to provide an additional layer of protection to the detergent body. Additionally/alternatively the coating may be used to attach a second or further detergent formulation to the original detergent formulation.

Where present the coating comprises 0.1 wt % to 5 wt %, preferably from 0.2 wt % to 2 wt % of the detergent formulation.

Preferred examples of coating materials include fatty acids, alcohols, diols, esters, ethers, mono and dicarboxylic acids, polyvinyl acetates, polyvinyl pyrrolidones, polylactic acids, polyethylene glycols and mixtures thereof.

Preferred mono-carboxylic acids comprise at least 4, more preferably at least 6, even more preferably at least 8 carbon atoms, most preferably between 8 and 13 carbon atoms. Preferred dicarboxylic acids include adipic acid, suberic acid, azelaic acid, subacic acid, undecanedioic acid, dodecandoic acid, tridecanedioic and mixtures thereof.

Preferred fatty acids are those having a carbon chain length of from C₁₂ to C₂₂, most preferably from C₁₈ to C₂₂. The coating layer may also include a disrupting agent. The detergent formulation may further include other common detergent components such as corrosion inhibitors, surfactants, fragrances, anti bacterial agents, preservatives, pigments and dyes.

The body which, at least partially, encloses the detergent formulation preferably has means to allow the detergent formulation to contact the wash liquor/be contacted by the wash liquor so that it may be released/dispersed into the wash liquor especially when the body is non-water soluble/dispersible. Such means preferably comprises an aperture which is optionally controlled by a water/temperature sensitive means.

This body may comprise a water soluble material, such as poly-vinyl-alcohol. More preferably this body comprises a non-water soluble/dispersible body

The non-water soluble/dispersible body preferably comprises a water-resistant material. Preferred materials include plastics materials such as alkene polymers, e.g. polypropylene. Plastics materials are most preferred due to their resilience and low cost (material and manufacturing costs).

The detergent body is preferably for use in an automatic washing process in an automatic washing machine. Most preferably the detergent body is for use in an automatic dishwashing process.

Optionally the detergent formulation is split into a plurality of portions by the non-water soluble/dispersible body.

According to a second aspect of the invention there is provided an injection moulding process for preparation of a multi-phase detergent body, the multi-phase detergent body comprising in one phase a dispersible/soluble detergent formulation and a second phase a non-water soluble/dispersible body which, at least partially, encloses the detergent formulation.

It will be appreciated that features of the first and third aspects of the invention shall apply mutatis mutantis to the second aspect of the invention.

It has been found that detergent bodies produced using the production process of the second aspect of the invention have excellent properties resulting from the injection moulding component.

Firstly, it has been observed that the bodies produced have a high density. This is especially beneficial where the body is for use in an automatic washing machine (particularly a dishwashing machine) as normally there is only limited space for accommodating the detergent body. Thus by using the process of the present invention a small dense detergent body may be produced, wherein the said body contains sufficient detergent active to achieve its washing requirements yet is able to fit into the space provided in a washing machine.

Additionally as the body is produced by an injection moulding process there is much greater flexibility over the shape of the body produced. This can be useful if the body has to be accommodated in a specific space (see the paragraph above). It is also useful from a design freedom/aesthetic view point; no longer need the detergent body be based on the limited range of shapes that can be produced by compression or extrusion, any moulded shape can be produced.

Furthermore it has been observed that when bodies are produced by injection moulding, wherein the bodies comprise a particulate component, there is much greater flexibility of particle size of the particulate component. This is in contrast to particulate bodies produced in a compression process wherein to produce coherent bodies there is usually an upper limit on the particle size of around 1500 μm: if the particle size is any greater the integrity of the body becomes compromised. Whereas in accordance with the process of the present invention bodies can be produced comprising a particulate component having a particle of bigger than 1500 μm.

The use of larger particle sizes in the bodies provides several advantages in the production process. Primarily the use of larger particle sizes permits the use of a lower amount of binder with obvious cost saving advantages. Also the problem of pipework/conduit vessel coating, which is a recognised issue for small particles (especially when used in small quantities) is vastly reduced.

It has also been observed that a broad range of particle sizes can be used in the process according to the present invention. This is in contrast to conventional compression processes wherein there is a need for a narrow particle size distribution to avoid segregation of ingredients.

A preferred particle size is between 50 μm and 2000 μm with any particle size distribution within these limits.

These advantages may be realised without incurring any detrimental effect on other tablet properties (such as strength, dissolution speed, etc)

The preferred processing method for a formulation comprising a binder is as follows:

a) Feed the detergent formulation components to the barrel (hopper) of the injection unit (injection unit is to be understood as being the barrel, the screw and the nozzle) of the injection moulding machine,

b) Cause the added admixture from step a) to be progressed along the barrel of the injection moulding machine towards the injection nozzle. As the admixture progresses along the barrel it is mixed and heated above the plastification temperature of the binder,

c) the admixture is injected into the mould at temperatures above the plastification temperature,

d) in the mould the admixture is allowed to chill, to form a shaped body,

e) the mould is optionally opened and the shaped body is ejected from the mould,

f) the detergent formulation shaped body is at least partially, enclosed within a non-water soluble/dispersible body.

The process may include the additional step (g): —

g) the body is packed (e.g. with foil wrapping, box or bag packing). The packaging material may be used to provide a moisture barrier.

In step (a) the component materials may be blended before addition to the barrel.

In step (a), as an alternative, one of the binder and/or lubricant components may be partially/fully added to the admixture inside the barrel of the injection unit of the machine by additional feeding stations.

In step (a) the component materials (particularly the binder) are added to the barrel preferably at a temperature below the plastification of the binder system to allow smooth feeding.

As an alternative in step (a) the component materials, optionally including the binder, may be heated above the plastification point of the binder and then added to the barrel.

In step (c) the pressure at the nozzle of the injection moulding machine while injecting is preferably less than 100 bar, more preferably less than 50 bar and most preferably less than 30 bar. Using these relatively low injection pressures (and consequently low injection temperatures) it has been found that the integrity (and hence the activity) of any enzyme present in the injected composition is largely preserved.

In an alternative embodiment the process is performed using an injection unit which comprises a barrel equipped with a piston to press the detergent composition into the mould. In this case the detergent composition needs to be heated above its plastification temperature and vigorously mixed before being placed in such injection unit. The detergent composition can then be injected into the mould.

The process is most preferably performed using a machine which comprises a plurality of injection units. Each injection unit is able to process a different composition.

Thus for manufacturing a multi phase detergent body the mould may be configured such that it can be accessed by a plurality of injection units. Thus a first injection unit may be used to inject a first composition into a first portion of the mould. Simultaneously (or subsequently) a second injection unit may be used to inject a second composition into a second portion of the mould. Movement of the mould relative to one or more of the injection units may occur at a part of the process.

As an alternative the mould may be opened after injection and chilling of the composition of the first phase of the detergent body. The original mould counter part which was moved in order to open the mould may be discarded and replaced with a second mould counter part. The mould may then be closed with the second mould counter part leaving a void space and the composition of the second phase injected therein.

As an further alternative the mould may be arranged such that it comprises a moveable member which affects the volume within the mould. Most preferably the member may be arranged in at least two orientations: in a first orientation a first volume is defined within the mould and in a second orientation a second (preferably larger) volume is defined within the mould. Thus a first composition may be injected into the mould with the member in its first orientation. The first injected composition may then be allowed to cool. The member may then be moved to its second orientation, thus realising a void space into which a second composition may be injected.

A yet further alternative is that the mould may be opened after injection and chilling of the composition of the first phase of the detergent body. The first phase of the detergent body may be expelled from the mould and inserted into a second mould which after closing comprises a void space. The composition of the second phase may be injected into the void space.

For all options above the described process steps may be repeated for the injection of a third/subsequent composition. A combination of the different alternatives may also be used.

It has been observed in the process according to the invention that it can be used for the production of multiphase detergent bodies having excellent properties. These properties include much greater flexibility in the relative arrangement of the phases as the arrangement of the phases in now no longer overruled by gravity and gravity controlled feed techniques as used in prior art multi-phased tablets produced by conventional compression processes.

Additionally the relative sizes of the phases is much more flexible: any relative size of phases is possible, no pre-set relationship is required as in extrusion processing prior art.

The invention is now described with reference to the following non-limiting examples. Further modifications within the scope of the invention will be apparent to the person skilled in the art.

### EXAMPLES

### 1. Multi-Dose Detergent for a Domestic Dishwasher

A multi-dose detergent formulation for an automatic dishwasher comprising a dishwasher detergent formulation contained within a water insoluble body (in this case a water-insoluble apertured beaker) was prepared as follows.

Firstly the beaker was prepared by injection moulding a suitable plastics formulation (e.g. polypropylene) in a mould.

Secondly the detergent formulation as injected into the same mould into beaker. Before injection the detergent formulation was mixed together and fed into the injection moulding machine. The mixture was heated to an elevated temperature less than 65° C. and injected at a pressure of less than 50 bar.

The detergent formulation had the following composition.

| | |
|---|---|
| Sodium Citrate | 50% |
| MGDA (sodium salt) | 10% |
| Sulphonated polymer* | 8% |
| Soda | 10% |
| Protease** | 0.9% |
| Amylase** | 0.5% |
| Nonionic Surfactant (liquid) | 1.4% |
| Nonionic Surfactant (solid) | 5% |
| Defoaming agent | 0.1% |
| Fragrance | 0.1% |
| PEG 1500 | 12.0% |
| Copolymer PVP_VA | 2% |

*Acusol 588
**in granular form

### 2. Multi-Dose Rinse Aid Block for a Domestic Dishwasher

A multi-dose rinse aid block was prepared as in Example 1.

The rinse aid mixture was heated to an elevated temperature less than 65° C. and injected at a pressure of less than 30 bar.

The rinse aid formulation had the following composition.

| | |
|---|---|
| Stearamide MEA | 21% |
| Nonionic Surfactant (I) | 15% |
| Nonionic Surfactant (II) | 20% |
| Fragrance | 0.1% |
| PEG 35000 | 42.9% |

### 3. Multi-Dose Glass Cleaner for Restaurants

A multi-dose glass cleaner block was prepared as in Example 1.

The glass cleaner mixture was heated to an elevated temperature less than 65° C. and injected at a pressure of less than 30 bar.

The glass cleaner formulation had the following composition.

| | |
|---|---|
| Nonionic Surfactant (solid) | 40% |
| Fragrance | 0.3% |
| PEG 35000 | 59.7% |

### 4. Candle in a Beaker

A candle in a beaker was prepared as follows.

Firstly the beaker was prepared by injection moulding a suitable plastics formulation (e.g. polypropylene) in a mould.

Secondly the candle formulation as injected into the same mould into beaker. Before injection the detergent formulation was mixed together and fed into the injection moulding machine. The mixture was heated to an elevated temperature less than 65° C. and injected at a pressure of less than 20 bar. The fragrance can be added at a later part of the extruder screw to avoid degradation of any temperature sensitive ingredients of the fragrance.

The candle formulation had the following composition.

| | |
|---|---|
| Beeswax | 97% |
| Fragrance | 3% |

Parafin wax or stearin may be used in an alternative to Beeswax.

### 5. Single-Dose Detergent for a Domestic Dishwasher

A single-dose detergent formulation for an automatic dishwasher comprising a dishwasher detergent formulation contained within a water soluble body (in this case a water-soluble pvoh resin) was prepared as follows. This is a multi-phase body according to the third aspect of the invention.

Firstly the water soluble body was prepared by injection moulding a suitable PVOH resin formulation (e.g. L753 from KSE or AX2000 from Nippon Goshei) in a mould.

Secondly the detergent formulation as injected into the same mould into the water soluble body. Before injection the detergent formulation was mixed together and fed into the injection moulding machine. The mixture was heated to an elevated temperature less than 65° C. and injected at a pressure of less than 50 bar.

The detergent formulation had the following composition (all percentages are by weight).

| | |
|---|---|
| Sodium Citrate | 52% |
| MGDA (sodium salt) | 10% |
| Sulphonated polymer* | 8% |
| Soda | 10% |
| Protease** | 0.9% |
| Amylase** | 0.5% |
| Nonionic Surfactant (liquid) | 1.4% |
| Nonionic Surfactant (solid) | 5% |
| Defoaming agent | 0.1% |
| Fragrance | 0.1% |
| PEG 1500 | 12.0% |

*Acusol 588
**in granular form

1. An injection molded multi-phase detergent body, the multi-phase detergent body comprising in one phase a dispersible and/or soluble detergent formulation and in a second phase a non-water soluble and/or dispersible body which, at least partially, encloses the dispersible and/or soluble detergent formulation.

2. A body according to claim 1, wherein the detergent formulation comprises a binder.

3. A body according to claim 2, wherein the binder is present at 5-50 wt % of the detergent body.

4. A body according to claim 3, wherein the binder comprises a thermoplastic material having a melting point of about 35° C.

5. A body according to claim 2 wherein the binder is PEG having a molecular mass of between 1500 to 35000.

6. A body according to claim 1, wherein the detergent formulation comprises a builder.

7. A body according to claim 6, wherein the detergent formulation comprises at least 50 wt % builders.

8. A body according to claim 7, wherein the builder is an alkali metal citrate salt.

9. A body according to claim 1, wherein the detergent formulation comprises a lubricant.

10. A body according to claim 9, wherein the lubricant is present at 0.1 to 10 wt %.

11. A body according to claim 1 wherein the detergent has a soluble coating.

12. An automatic washing machine multi-phase detergent body having a body according to claim 1.

13. An injection moulding process for the preparation of a multi-phase detergent body, the multi-phase detergent body comprising in one phase a dispersible and/or soluble detergent formulation and in a second phase a non-water soluble and/or dispersible body which, at least partially, encloses the soluble and/or dispersible detergent formulation.

14. A process, according to claim 13 wherein the detergent formulation comprises a binder, the process comprising the following steps:
a) feeding the components of the dispersible/soluble detergent formulation to the barrel of an injection unit of an injection moulding machine to form an admixture,
b) causing the admixture from step a) to be progressed along the barrel of the injection moulding machine towards an injection nozzle,
c) injecting the admixture into a mould at a temperature above the plastification temperature of the binder,
d) allowing the admixture to chill in the mould to form a detergent formulation shaped body,
e) optionally opening the mould and ejecting the shaped body therefrom,
f) at least partially enclosing the detergent formulation within a non-water soluble/dispersible body.

15. A process according to claim 14, wherein the body is packed with a packaging material.

16. A process according to claim 14, wherein the components are blended before addition to the barrel.

17. A process according to claim 13, wherein the detergent formulation comprises a lubricant.

18. A process according to claim 14 wherein the binder and/or lubricant is/are partially or fully added to the admixture inside the barrel of the injection unit of the machine by additional feeding stations.

19. A process according to claim 14, wherein in step (a) the components are added to the barrel at a temperature below the plastification temperature of the binder.

20. A process according to claim 14, wherein in step (a) the components are added to the barrel at a temperature above the plastification temperature of the binder.

21. A process according to claim 14, wherein in step (c) the pressure at the nozzle of the injection moulding machine while injecting is preferably less than 100 bar.

22. A process according to claim 14, wherein the process is performed using a machine which comprises a plurality of injection units with each injection unit able to process a different composition.

23. An injection molded multi-phase body comprising in one phase a first formulation and in a second phase a body which, at least partially, encloses the first formulation.
